(19) United States
(12) Patent Application Publication
(10) Pub. No.: US 2013/0163087 A1
(43) Pub. Date: Jun. 27, 2013

(54) GLASS SUBSTRATE COATED WITH AN ANTI-REFLECTIVE LAYER

(71) Applicants: Francois Lecolley, Jumet (BE); Jean-Francois Oudard, Jumet (BE)

(72) Inventors: Francois Lecolley, Jumet (BE); Jean-Francois Oudard, Jumet (BE)

(73) Assignees: AGC Glass Europe, Bruxelles(Watermael-Boitsfort) (BE); AGC Flat Glass North America, Inc., Alpharetta, GA (US); Asahi Glass Company, Tokyo (JP)

(21) Appl. No.: 13/820,275

(22) PCT Filed: Aug. 31, 2011
(86) PCT No.: PCT/EP11/64935

§ 371 Date: Mar. 1, 2013

(30) Foreign Application Priority Data
Sep. 1, 2010 (EP) 10174923.2
Jun. 29, 2011 (EP) 11171971.2

(51) Int. Cl. G02B 1/11

(52) U.S. Cl. CPC G02B 1/115
USPC 359/601; 65/17.2

(57) ABSTRACT

The invention relates to a coated glass substrate, especially a glass substrate comprising an anti-reflective layer (AR) with improved opto-energetic performances and a good mechanical and chemical durability. The glass substrate according to the invention comprises a glass sheet provided with a porous AR layer comprising a majority of silicon oxide in the form of (i) a sol-gel type matrix and (ii) particles. Advantageously, the AR layer also comprises a quantity of aluminium oxide, expressed in the form of Al2O3, that is more than or equal to 2 weight per cent and less than or equal to 5 weight per cent. Said layer also comprises at least 55 weight per cent of particles and a maximum of 80 weight per cent of particles in relation to the total weight of silicon oxide.

The present invention relates to a coated glass substrate, in particular a glass substrate comprising an antireflective (AR) layer with improved opto-energetic transmission performance and with good mechanical and chemical durability.

Antireflective layers are widely used in order to increase light and energy transmission and to eliminate reflections from glass. Reducing the reflection of light at the surface of a glass substrate is desired for numerous applications such as window panes, picture frames, photovoltaic devices (for example solar cells), greenhouses, etc. In particular, in the case of solar applications of photovoltaic type, it is obviously very advantageous to reduce the amount of radiation that is reflected by the glass substrate of a solar cell, thus increasing the amount of radiation which continues its path to the active layer (for example a photoelectric transfer film, for instance a semiconductor such as amorphous silicon, microcrystalline silicon or a photoelectrically active layer chosen from CdTe, a copper-indium-gallium-selenium alloy, the concentration of indium and of gallium possibly varying from pure copper indium selenide to pure copper gallium selenide, or a copper-indium-selenium alloy, these alloys being known to those skilled in the art under the abbreviation CIGS or CIS.

In the case of antireflective layers intended for reducing or eliminating reflections from glass, the material most commonly used is silica or silicon oxide, in monolayer or stacked form. In particular, monolayers of porous silicon oxide give good performance qualities in terms of antireflection properties. In general, the higher the porosity, the lower the refractive index of the coating. Thus, it has been demonstrated that by acquiring sufficient porosity, silica coatings with refractive indices of from 1.2 to 1.3 may be produced. As a guide, a layer of non-porous silica (dense) typically has a refractive index of about 1.45.

Such porous layers are typically obtained by introducing a pore-forming agent into the precursor intended for depositing said layer. This pore-forming agent may be of organic nature, and its subsequent combustion then creates the pores in the layer. It may also be of mineral nature, in the form of particles, and thus remains in the layer even after a heat treatment step. In particular, it has been shown that it is possible to generate a porous silica layer by combining particles of colloidal silica and of silica originating from a precursor of silane type in a process of sol-gel type.

Nevertheless, such antireflective layers made of porous silica have drawbacks. Specifically, increasing the porosity of coatings in general results in a reduction of their mechanical strength and chemical resistance, which is why problems exist in terms of durability with respect to the external environment and of degradation due to abrasion effects during, for example, the cleaning of the coatings.

To reduce this phenomenon of reduction of the mechanical strength and/or chemical resistance of the porous silica coating, it may be doped, for example via the incorporation of elements such as Al, Zr, B, Sn or Zn in oxide form. In particular, aluminum is known to give good results in this context. Unfortunately, due to the significantly higher refractive index of aluminum oxide relative to silica (of about 1.67 as a dense layer) and even relative to glass (1.51), this incorporation results in an increase in the refractive index of the doped layer and a reduction of its antireflection performance qualities.

The object of the invention is especially to overcome the latter drawbacks by solving the technical problem, namely by providing a porous antireflective layer that has sufficient mechanical strength and chemical resistance, while at the same time not detrimentally affecting the light transmission through the glass substrate which it covers, or even while improving the same.

In at least one of its embodiments, an object of the invention is also to provide a solution to the prior art drawbacks that is simple, rapid and economical.

In at least one of its embodiments, another object of the invention is to perform a process for manufacturing a glass substrate comprising an antireflective layer, said process being easy and flexible.

In accordance with a particular embodiment, the invention relates to a glass substrate comprising a glass sheet provided, on at least part of at least one of its faces, with a porous antireflective layer, said layer predominantly comprising silicon oxide, SiO₂, present in the form (i) of a matrix of sol-gel type and (ii) of particles.

According to the invention, the porous antireflective layer also comprises aluminum oxide in an amount, expressed in the form of Al₂O₃, of greater than or equal to 2.0% by weight and preferentially greater than or equal to 2.5% and less than or equal to 5.0% by weight and preferentially less than or equal to 4.1% by weight, and it also comprises at least 55% by weight of particles and preferentially at least 60% by weight of particles and not more than 80% by weight of particles, preferentially not more than 75% by weight of particles, more preferentially not more than 70% by weight of particles and most preferentially not more than 65% by weight of particles relative to the total weight of silicon oxide.

Thus, the invention is based on an entirely novel and inventive approach since it makes it possible to solve the drawbacks of the prior art and to overcome the technical problem posed. Specifically, the inventors have demonstrated that it is possible, by combining
a silicon oxide matrix of sol-gel type;
silicon oxide particles in a precise amount; and
aluminum oxide also in a precise amount;
   to obtain an antireflective layer that has good mechanical strength and chemical resistance, but which above all shows improved antireflective properties. This result is very surprising insofar as, as has been mentioned previously, aluminum oxide (or alumina) intrinsically has a higher refractive index than silica. In addition, the inventors have determined, surprisingly, that an antireflective layer comprising at least 55% by weight of particles and preferentially at least 60% by weight of particles and not more than 80% by weight of particles, preferentially not more than 75% by weight of particles, more preferentially not more than 70% by weight of particles and most preferentially not more than 65% by weight of particles, relative to the total weight of silicon oxide, makes it possible to obtain a compromise between, on the one hand, the improvement of the antireflection properties of the layer and, on the other hand, the mechanical strength of the layer. Moreover, the inventors have also determined, surprisingly, that the addition of aluminum oxide, expressed in the form of Al₂O₃, in a large amount, greater than or equal to 2.0% by weight and preferentially greater than or equal to 2.5% and less than or equal to 5.0% by weight and preferentially less than or equal to 4.1% by weight, makes it possible to improve the antireflection properties of the layer while at the same time keeping the amount of colloidal silica constant, this improvement in the optical performance of the antireflective layer not being accompanied by a deterioration in the mechanical durability of the antireflective layer.

According to a preferred embodiment, the glass substrate according to the invention comprises, consists or consists essentially of a glass sheet provided, on at least part of at least one of its faces, with a porous antireflective layer, said layer predominantly comprising silicon oxide, SiO₂, present in the form (i) of a matrix of sol-gel type and (ii) of particles, such that the porous antireflective layer also comprises aluminum oxide, expressed as Al₂O₃, in an amount ranging from 2.0% to 5.0%, preferentially ranging from 2.0% to 4.1% by weight and more preferentially ranging from 2.5% to 4.1% by weight, and such that it also comprises between 55% and 80% by weight of particles, 60% and 75% by weight of particles, preferentially between 60% and 70% by weight of particles and most preferentially between 60% and 65% by weight of particles, relative to the total weight of silicon oxide.

According to the invention, the glass substrate comprises a glass sheet. The glass according to the invention may belong to various categories. The glass may thus be a glass of sodium-calcium type, a boron glass, a glass comprising one or more additives uniformly distributed in its mass, for instance at least one inorganic colorant, an oxidizing compound, a viscosity regulator and/or a melting adjuvant. Preferably, the glass of the invention is of sodium-calcium type. The glass of the invention may be a floated glass, a drawn glass or a glass that is printed or textured, for example by a roller or by acidic or alkaline attack. It may be clear, extra-clear, frosted and/or matt: preferably, the glass is an extra-clear glass. The term “sodium-calcium glass” is used herein in its broad sense and concerns any glass that contains the following base components (expressed as total weight percentages of glass):

| | |
|---|---|
| SiO₂ | 60% to 75% |
| Na₂O | 10% to 20% |
| CaO | 0 to 16% |
| K₂O | 0 to 10% |
| MgO | 0 to 10% |
| Al₂O₃ | 0 to 5% |
| BaO | 0 to 2% |
| BaO + CaO + MgO | 10% to 20% |
| K₂O + Na₂O | 10% to 20% |

It also denotes any glass comprising the preceding base components, which may also comprise one or more additives.

The glass sheet of the invention may have a thickness ranging, for example, from 2 to 10 mm.

According to a preferred embodiment, in particular in the case of solar applications, the glass sheet is a sheet of printed or textured glass, i.e. it has a macroscopic relief, for example in the form of patterns of the pyramid or cone type, the patterns possibly being convex (protruding relative to the general plane of printed face) or concave (hollowed into the mass of the glass). Preferably, the glass sheet is printed or textured on at least one of its faces. Such a glass substrate that is both textured and coated with an antireflective layer cumulates the effect of trapping light and the antireflection effect.

According to this preferred embodiment, the face of the glass substrate that is coated with the porous layer is, advantageously, the one that is not textured.

Preferably, in the case of solar applications, the glass sheet is made of an extra-clear glass. The term “extra-clear glass” means a glass whose composition comprises less than 0.06% by weight of total iron, expressed in the form of Fe₂O₃, and preferably less than 0.02% by weight of total iron, expressed in the form of Fe₂O₃.

According to the invention, and in the absence of further precision, the term “layer” means either a single layer (monolayer) or a superposition of strata (multilayer). According to an advantageous embodiment, the layer may be in the form of a superposition of strata. It may especially be preferred to manufacture strata that are increasingly porous the more removed from the supporting substrate, and/or strata of different thicknesses, in order further to improve the antireflection effect.

According to the invention, the glass substrate is coated with a porous antireflective layer on at least part of at least one of its faces. The layer may extend continuously over substantially all the surface of the substrate, for example over more than 90% of its surface and preferentially over more than 95% of its surface.

Alternatively, the layer may partially cover the surface of the substrate. The substrate may also be coated on each of its faces, partially or totally with said layer.

According to the invention, the porous antireflective layer predominantly comprises silicon oxide present in the form (i) of a matrix of sol-gel type and (ii) of particles.

The expression “predominantly comprising silicon oxide” means that the layer according to the invention consists of silicon oxide, SiO₂, in a proportion of at least 80% by weight relative to the total weight of the layer and preferably of at least 90% by weight.

According to the invention, the SiO₂ matrix is an essentially continuous and amorphous solid phase. It is obtained via the well-known sol-gel process. This matrix will constitute the “binder” for the silica particles also present in the layer. It is the combination of the matrix derived from a sol-gel process with the particles (pore-forming agent) which will generate the porous structure of the layer of the invention.

The particles of the invention may be solid or hollow. They may be, for example, in virtually spherical or elongated form (for example in the form of rods). Preferentially, the particles have an elongated form, and more preferentially are in the form of rods, the inventors having determined that this type of particle makes it possible to obtain a porosity ranging up to 50% by volume of trapped air and, as a result, the use of this type of particle ensures an increased antireflective effect. In comparison, a random stack of spherical particles makes it possible to obtain a maximum porosity of about 36% and a compact hexagonal stack of these same spherical particles produces a maximum porosity of about 24%.

According to a preferred embodiment of the invention, the particles are nanoparticles.

Preferably, the particles of the invention have a size that is not less than 2 nm and preferably not less than 5 nm. Furthermore, the particles have a size that is not greater than 500 nm and preferably not greater than 250 nm. The term “size” denotes the largest dimension of the particles (the diameter for a sphere, the length for an elongated particle, etc.).

The layer according to the invention may comprise particles of different or similar sizes and/or forms, said particles preferably forming chains.

According to a preferred embodiment of the invention, the porous antireflective layer has a thickness of between 50 nm and 300 nm, preferentially between 70 nm and 250 nm, more preferentially between 80 nm and 200 nm and most preferentially between 80 nm and 150 nm. The inventors have determined, surprisingly, that such thicknesses of antireflection layer make it possible to obtain improved opto-energetic performance qualities particularly in the wavelength range from 400 to 1100 nm.

According to another preferred embodiment, a substantially non-porous undercoat is interposed between the glass sheet and the antireflective layer. The expression “substantially non-porous undercoat” means a “dense” layer, in other words an undercoat having a higher density than that of the porous antireflective layer. The undercoat of the invention may act, for example, as an alkali barrier.

According to this embodiment, the undercoat preferably comprises at least one compound chosen from zirconium oxide, titanium oxide, aluminum oxide, silicon oxide and silicon oxynitride. Preferably, the undercoat predominantly comprises a compound chosen from zirconium oxide, titanium oxide, aluminum oxide, silicon oxide and silicon oxynitride. More preferably, the undercoat predominantly comprises silicon oxide. The expression “an undercoat predominantly comprising one of the compounds from the above list” means an undercoat consisting of said compound to a proportion of at least 80% by weight relative to the total weight of the layer, and preferably of at least 90% by weight. Preferably, the undercoat comprises a compound chosen from zirconium oxide, titanium oxide, aluminum oxide, silicon oxide and silicon oxynitride, said compound being combined with an additional compound selected from zirconium oxide, titanium oxide, aluminum oxide and silicon oxide. The additional oxide(s) may represent not more than 10% by weight and preferably not more than 5% of the whole. Most preferentially, the undercoat is based on silicon oxide, said silicon oxide being combined with at least one other oxide selected from the group comprising zirconium oxide, titanium oxide and aluminum oxide. The respective proportions of silicon oxide and of the other oxides are such that the refractive index of the undercoat is between the refractive index values of the glass sheet and the refractive index of the porous antireflective layer, said refractive indices being measured at a wavelength of 550 nm. Preferably, the undercoat has a thickness that is between 5 nm and 200 nm and preferentially between 50 nm and 150 nm.

The undercoat according to the invention may also be deposited via the sol-gel method, but also via the vapor-phase deposition method (CVD) or by cathodic sputtering. Preferentially, the undercoat is deposited via the sol-gel method, the inventors having determined, surprisingly, that an undercoat deposited via the sol-gel method makes it possible to obtain better adhesion of the porous antireflective layer, more particularly when said undercoat is subjected, after applying the sol-gel solution that is the origin of said undercoat to the glass sheet and preferably before applying the sol-gel solution that is the origin of the porous antireflective layer, to a heat treatment below or equal to a temperature of 200° C. In addition, the inventors have determined, surprisingly, that an undercoat deposited via the sol-gel method, although less dense, has a sufficient alkali barrier property.

The glass substrate according to the invention may also comprise an overcoat, deposited on the antireflective layer. Such an overcoat may, for example, further reinforce the chemical durability of the antireflective layer in the case of external applications or applications in a humid medium, for example.

Another subject of the invention concerns the process for manufacturing the glass substrate comprising an antireflective layer according to the invention. Said process is such that it comprises the following steps for forming the antireflective layer, in this order:

a) the preparation of a “sol” of a silicon-based precursor in a solvent, which is especially aqueous and/or alcoholic, at acidic pH;
b) the addition of an aluminum-based precursor to the sol prepared in step (a);
c) the mixing of the “sol” with silica particles;
d) the deposition onto a glass sheet of the sol/particles mixture; and
e) the heat treatment of the coated glass sheet, said treatment advantageously corresponding to tempering of the glass sheet when thermal tempering of said sheet is necessary;
the first two steps may be performed simultaneously or successively. The silicon-based precursor is preferably a hydrolyzable compound such as a silicon alkoxide. The aluminum-based precursor may be chosen especially from alkoxides, nitrate and acetylacetonate.

Advantageously, the silica particles are added to the sol in the form of a dispersion in a liquid (for example water).

The deposition of the sol/particles mixture onto the substrate may be performed by spraying, by dipping and withdrawing using the silica sol (dip coating), by centrifugation (spin coating), by pouring (flow coating) or by roller (roll coating).

The process may preferably comprise a step of drying or of removal of the solvent(s), at a temperature below about 200° C. and preferably below about 150° C., intervening just after the deposition step and before the heat treatment of the coated glass sheet from step (e).

According to an advantageous embodiment, the process for manufacturing the glass substrate according to the invention is such that it comprises, prior to the deposition of the antireflective layer, the following steps, in this order:

1) the preparation of a “sol” of a silicon-based precursor in a solvent, which is especially aqueous and/or alcoholic, at acidic pH;
2) the addition of an aluminum-based and/or zirconium-based precursor to the sol prepared in step (1);
3) the deposition onto a glass sheet of the mixture of the solution resulting from steps 1) and 2) by spraying, by dipping and withdrawing using the silica solution (dip coating), by centrifugation (spin coating), by pouring (flow coating) or by roller (roll coating); and
4) the heat treatment for drying or removal of the solvent(s) from the coated glass sheet at a temperature of less than or equal to 200° C. and preferentially less than or equal to 150° C.,
the first two steps may be performed simultaneously or successively. The silicon-based precursor is preferably a hydrolyzable compound such as a silicon alkoxide. The aluminum-based and/or zirconium-based precursor may be chosen especially from alkoxides, nitrate and acetylacetonate.

The heat treatment of the glass sheet coated with all its layers may be performed at temperatures of the order of 300° C. to 720° C., preferentially of the order of 300° C. to 680° C., for example of the order of 300° C. to 650° C. or, for example, from 300° C. to 550° C. and allows the condensation/formation of the porous layer based on silica and alumina.

The coated glass substrate according to the invention may also subsequently be heat-treated for the purpose of tempering it or of curving it. Advantageously, the final step of the process of the invention (condensation/formation of the layer) may also correspond to a heat treatment for the purpose of tempering or curving the substrate, if it is performed under conditions that are suitable, respectively, for these two operations (typically at temperatures that are not below 500° C. and even of the order of 600-700° C.). The porous layer according to the invention may indeed withstand such a heat treatment without any significant impairment in its opto-energetic properties.

Glass substrates in accordance with the invention may have varied applications. These substrates may be used as glazing for aquariums, window panes (interior or exterior), greenhouses, picture frames or paintings, etc. They may also be used in fields such as aeronautical, maritime or terrestrial transport (for example windshields), for buildings or for domestic appliances. Very advantageously, they may be used in applications of the solar type. They are used especially in solar panels, in particular thermal solar collectors or photovoltaic cells.

Thus, a subject of the invention is also a solar cell comprising the glass substrate coated with an antireflective layer according to the invention.

Other characteristics and advantages of the invention will emerge more clearly on reading the following description of preferential embodiments, which are given as simple nonlimiting illustrative examples, and of the attached figures, among which:

FIG. 1 is a cross section of a glass substrate according to the invention (1) comprising a glass sheet (10) and a porous antireflective layer (12);

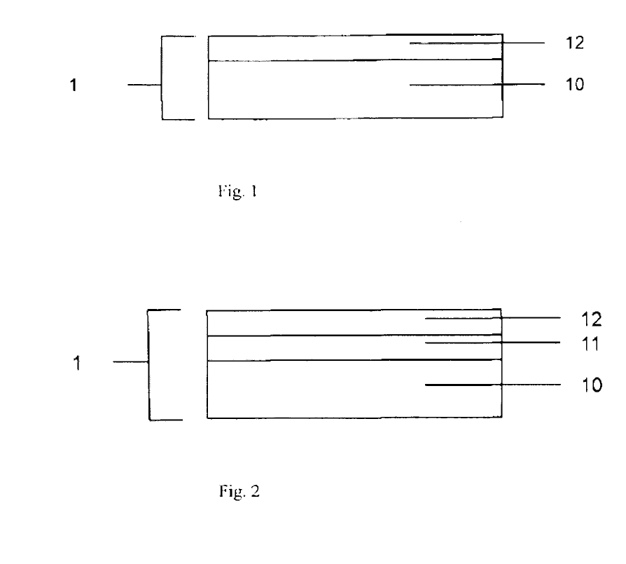

FIG. 2 is a cross section of a glass substrate according to the invention (1) comprising a glass sheet (10), an undercoat (11) and a porous antireflective layer (12);

FIG. 3 is a graph showing the transmission profiles of a glass substrate according to the invention (B), of a glass substrate coated with a porous antireflective layer not in accordance with the invention, not containing any aluminum oxide (C), a glass substrate coated with a porous antireflective layer not in accordance with the invention, containing an amount of 6.0% by weight of aluminum oxide (D), and of an uncoated glass substrate of the same nature (A);

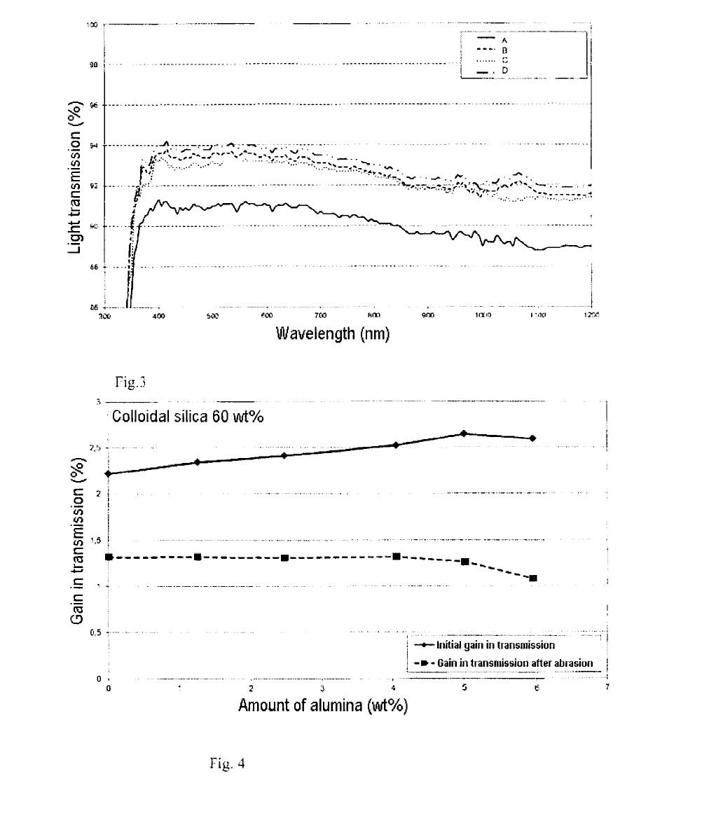

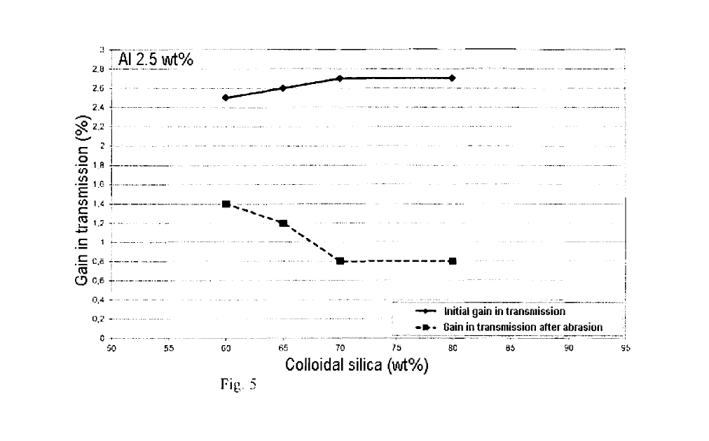

FIG. 4 is a graph showing the evolution of the gain in transmission of a glass substrate according to the invention as a function of the amount of alumina present in the antireflection layer of said glass substrate relative to an uncoated glass substrate of the same nature, for a porous antireflective layer in which the amount of silica particles constitutes 60% by weight of the total silica;

FIG. 5 is a graph showing the evolution of the gain in transmission of a glass substrate according to the invention as a function of the weight percentage of colloidal silica, with a constant amount (2.5% by weight) of alumina in the antireflection layer of said glass substrate relative to an uncoated glass substrate of the same nature.

The examples that follow illustrate the invention without limiting its scope in any way.

### EXAMPLES

Formulation for the undercoat: a solution was prepared by mixing nitric acid (0.090 kg) with distilled water (11.850 kg) and ethanol (80.180 kg). Tetraethyl orthosilicate (7.670 kg) was added to this mixture and the solution was then left to react for one hour at room temperature with stirring. Zirconium acetylacetonate (0.180 kg) was then added. The solution was stirred for a further 30 minutes.

Mixture 1 (comparative): a formulation was prepared by mixing ethanol (53.230 kg), butanol (24.000 kg) and 4-hydroxy-4-methyl-2-pentanone (16.000 kg). Nitric acid (0.015 kg) and distilled water (1.980 kg) were added to this mixture. Next, tetraethyl orthosilicate (TEOS: 1.280 kg) was added and the solution was then left to react with stirring for one hour at room temperature in order to allow hydrolysis of the silicon-based precursor. After this stirring period, silica particles dispersed in water (Snowtex OUP colloidal silica from Nissan Chemical Industries Ltd: 3.430 kg) were finally added to the “sol” obtained in the preceding step. The colloidal silica Snowtex OUP consists of elongated silica particles having characteristic dimensions of the order of 9-15 nm and 40-100 nm and forming interlinked particle chains.

This formulation corresponds to an amount of silica particles of 59% by weight of total silica.

Mixture 2 (comparative): a formulation was prepared by mixing ethanol (52.920 kg), butanol (24.000 kg) and 4-hydroxy-4-methyl-2-pentanone (16.000 kg). Nitric acid (0.015 kg) and distilled water (1.930 kg) were added to this mixture. Next, tetraethyl orthosilicate (TEOS: 1.250 kg) was added and the solution was then left to react with stirring for one hour at room temperature in order to allow hydrolysis of the silicon-based precursor. Aluminum acetylacetonate Al(acac)₃ (0.360 kg) was then added and the solution was again stirred for a further 30 minutes. After this stirring period, silica particles dispersed in water (Snowtex OUP colloidal silica from Nissan Chemical Industries Ltd: 3.490 kg) were finally added to the “sol” obtained in the preceding step. The colloidal silica Snowtex OUP consists of elongated silica particles having characteristic dimensions of the order of 9-15 nm and 40-100 nm and forming interlinked particle chains.

This formulation corresponds to an amount of silica particles of 60% by weight of total silica and to an amount of aluminum oxide, expressed in the form of Al₂O₃, of 6.0% by weight.

Mixture 3 (according to the invention): a formulation was prepared by mixing ethanol (53.040 kg), butanol (24.000 kg) and 4-hydroxy-4-methyl-2-pentanone (16.000 kg). Nitric acid (0.0150 kg) and distilled water (1.930 kg) were added to this mixture. Next, tetraethyl orthosilicate (TEOS: 1.250 kg) was added and the solution was then left to react with stirring for one hour at room temperature in order to obtain a “sol”. Aluminum acetylacetonate Al(acac)₃ (0.240 kg) was then added and the solution was again stirred for a further 30 minutes. After this, Snowtex OUP colloidal silica (3.490 kg) from Nissan Chemical Industries Ltd. was finally added.

This formulation corresponds to an amount of silica particles of 60.0% by weight of total silica and to an amount of aluminum oxide, expressed in the form of Al₂O₃, of 4.0% by weight.

Deposition on glass: the undercoat formulation was deposited on one of the faces of three 10 cm×10 cm extra-clear glass sheets via a “dip coating” process (immersion followed by withdrawal). The substrates thus obtained were dried in an oven at 120° C. for 10 minutes. In a second stage, mixture 1, 2 or 3 was deposited onto one of the substrates obtained, also via a “dip coating” process under experimental conditions that were identical for each. The heat treatment of the final glass sheet/undercoat/layer assembly was performed during a process of thermal tempering of the glass, performed under standard conditions (680° C. for 180 seconds).

Optical properties: the optical properties of the glass substrates coated using mixtures 1, 2 and 3 (respectively, substrate 1, 2 and 3) are represented in the graph of FIG. 3, showing the transmission T between 300 and 1200 nm (curve (C) for substrate 1, curve (D) for substrate 2 and curve (B) for substrate 3). They are compared with those of a glass substrate that is identical but not coated (reference, curve (A)). These optical properties are measured according to standard ISO 9050: 2003.

A 2.2% increase in light transmission is observed over the range 300-1100 nm for the substrate obtained with mixture 1 relative to the reference.

A 2.6% increase in light transmission is observed over the range 300-1100 nm for the substrate obtained with mixture 2 relative to the reference.

A 2.5% increase in light transmission is observed over the range 300-1100 nm for the glass substrate according to the invention produced with mixture 3 relative to the reference.

Consequently, an increase in the performance of the antireflective layer according to the invention (0.3% increase in transmission) is obtained by combining alumina with a sol-gel matrix and silica particles, in given amounts. Such a gain is truly significant, in particular in the field of solar applications where the slightest increase in light transmission can result in a very significant increase in the yield.

Furthermore, the glass substrates obtained starting with mixtures 1, 2 and 3 were subjected to tests intended to evaluate their chemical and mechanical durability. In particular, the maintenance of their opto-energetic performance qualities in tests under drastic conditions was checked. The results obtained are collated in the table below.

| | | Sub- | Sub- | |
|---|---|---|---|---|
| | | strate 1 | strate 2 | |
| | | (com- | (com- | Sub- |
| | | parative) | parative) | strate 3 |
| Initial gain in transmission (before test) | | 2.2% | 2.6% | 2.5% |
| Gain in | Abrasion test (500 cycles) | 1.4% | 1.1% | 1.4% |
| trans- | (standard EN 1096-2) | | | |
| mission | Humidity test (1000 h) | 2.0% | — | 2.3% |
| after test | (standard IEC 61215) | | | |
| | Test under pressure (9 h) | 1.8% | — | 2.0% |
| | Thermal cycles (1500 h) | 1.8% | — | 2.5% |
| | (standard IEC 61215) | | | |
| | Saline test (4 days) | 2.1% | — | 2.4% |
| | (standard IEC 1701) | | | |
| | Saline test (21 days) | 2.1% | — | 2.2% |
| | (standard EN 1096-2) | | | |

The improvement in the opto-energetic performance of the substrate according to the invention (substrate 3) is therefore not accompanied by a deterioration in the mechanical or chemical durability of the antireflective layer. On the whole, the chemical and mechanical durability properties of the layer according to the invention are similar to those of the antireflective layer of the comparative example (substrate 1) for all the standard tests performed. In addition, the comparison of the gain in transmission before and after abrasion shows the advantage of limiting the amount of aluminum oxide in the porous antireflective layer, the decrease in the gain in transmission after abrasion being greater for substrate 2, not in accordance with the invention, comprising an amount of aluminum oxide, expressed in the form of Al₂O₃, of 6.0% by weight, than for substrate 3 in accordance with the invention, said substrate 3 comprising an amount of aluminum oxide, expressed in the form of Al₂O₃, of 4.1% by weight. This effect is exemplified in FIG. 4, which shows the evolution of the gain in transmission of the porous antireflective layer before and after abrasion, as a function of the amount of aluminum oxide present in the porous antireflective layer, for a porous antireflective layer in which the amount of silica particles constitutes 60% by weight of the total silica. It is observed that the best compromise between, on the one hand, the gain in transmission and, on the other hand, the abrasion resistance, is obtained for amounts of aluminum oxide, expressed in the form of Al₂O₃, ranging from 2.0% to 5.0% by weight, preferentially ranging from 2.0% to 4.1% by weight and more preferentially from 2.5% to 4.1% by weight.

Moreover, the comparison of the gain in transmission before abrasion shows the advantage of adding aluminum oxide to the porous antireflective layer, the increase in the gain in transmission before abrasion being greater for substrate 3 in accordance with the invention than for substrate 1, not in accordance with the invention, not comprising any aluminum oxide.

FIG. 5 shows the evolution of the gain in transmission of the porous antireflective layer before and after abrasion, as a function of the amount of colloidal silica present in the layer, for a porous antireflective layer containing an amount of aluminum oxide, expressed in the form of Al₂O₃, equal to 2.5% by weight. It is observed that the best compromise between, on the one hand, the gain in transmission and, on the other hand, the abrasion resistance, is obtained for amounts of silica particles of between 55% and 80% by weight of particles, preferentially between 60% and 75% by weight of particles, more preferentially between 60% and 70% by weight of particles and most preferentially between 60% and 65% by weight of particles, relative to the total weight of silicon oxide.

1. A glass substrate (1) comprising a glass sheet (10) provided, on at least part of at least one of its faces, with a porous antireflective layer (12), said layer (12) predominantly comprising silicon oxide, SiO₂, present in the form (i) of a matrix of sol-gel type and (ii) of particles;
characterized in that said layer (12) also comprises aluminum oxide in an amount, expressed in the form of Al₂O₃, of greater than or equal to 2.0% by weight and preferentially greater than or equal to 2.5% and less than or equal to 5.0% by weight and preferentially less than or equal to 4.1% by weight, and in that it also comprises at least 55% by weight of particles and preferentially at least 60% by weight of particles and not more than 80% by weight of particles, preferentially not more than 75% by weight of particles, more preferentially not more than 70% by weight of particles and most preferentially not more than 65% by weight of particles relative to the total weight of silicon oxide.

2. The glass substrate (1) according to the preceding claim, characterized in that the porous antireflective layer (12) comprises aluminum oxide, expressed in the form of Al₂O₃, ranging from 2.0% to 5.0%, preferentially from 2.0% to 4.1% and more preferentially from 2.5% to 4.1% by weight.

3. The glass substrate (1) according to any one of claim 1 or 2, characterized in that the layer (12) comprises between 55% and 80% by weight of particles relative to the total weight of silicon oxide, preferentially between 60% and 75% by weight of particles, more preferentially between 60% and 70% by weight of particles and most preferentially between 60% and 65% by weight of particles, relative to the total weight of silicon oxide.

4. The glass substrate (1) according to any one of claims 1 to 3, characterized in that the particles have an elongated form, and are preferentially in the form of rods.

5. The glass substrate (1) according to any one of claims 1 to 4, characterized in that the particles have a size of between 2 and 500 nm.

6. The glass substrate (1) according to any one of claims 1 to 5, characterized in that the silica particles form chains.

7. The glass substrate (1) according to any one of claims 1 to 6, characterized in that the antireflective layer (12) has a thickness of between 50 and 300 nm, preferentially between 70 nm and 250 nm, more preferentially between 80 nm and 200 nm and most preferentially between 80 nm and 150 nm.

8. The glass substrate (1) according to any one of claims 1 to 7, characterized in that a substantially non-porous undercoat (11) is interposed between said glass sheet (10) and said antireflective layer (12).

9. The glass substrate (1) according to claim 8, characterized in that the undercoat (11) comprises at least one compound chosen from zirconium oxide, titanium oxide, aluminum oxide, silicon oxide and silicon oxynitride.

10. The glass substrate (1) according to 9, characterized in that the undercoat (11) predominantly comprises a compound chosen from zirconium oxide, titanium oxide, aluminum oxide, silicon oxide and silicon oxynitride, preferentially silicon oxide.

11. The glass substrate (1) according to any one of claims 8 to 10, characterized in that the undercoat (11) has a thickness of between 5 and 200 nm.

12. The glass substrate (1) according to any one of claims 1 to 11, characterized in that the glass sheet (10) is a sheet of glass of sodium-calcium type, preferably a sheet of extra-clear glass.

13. A process for manufacturing the glass substrate (1) according to any one of claims 1 to 12, characterized in that said process is such that it comprises the following steps for forming the antireflective layer (12), in this order:
a) the preparation of a “sol” of a silicon-based precursor in a solvent, which is especially aqueous and/or alcoholic, at acidic pH;
b) the addition of an aluminum-based precursor to the sol prepared in step (a);
c) the mixing of the “sol” with silica particles;
d) the deposition onto a glass sheet (10) of the sol/particles mixture; and
e) the heat treatment of the coated glass sheet (10),
the first two steps may be performed simultaneously or successively.

14. The manufacturing process according to claim 13, characterized in that it comprises, prior to the deposition of the antireflective layer (12), the following steps, in this order:
1) the preparation of a “sol” of a silicon-based precursor in a solvent, which is especially aqueous and/or alcoholic, at acidic pH;
2) the addition of an aluminum-based and/or zirconium-based precursor to the sol prepared in step (1);
3) the deposition onto a glass sheet (10) of the mixture of the solution resulting from steps 1 and 2 by spraying, by dipping and withdrawing using the silica solution (dip coating), by centrifugation (spin coating), by pouring (flow coating) or by roller (roll coating); and
4) the heat treatment for drying or removal of the solvent(s) from the coated glass sheet (10) at a temperature of less than or equal to 200° C. and preferentially less than or equal to 150° C.,
the first two steps may be performed simultaneously or successively.

15. The use of the glass substrate (1) according to any one of claims 1 to 14, in applications of the solar type, especially solar panels, thermal solar collectors or photovoltaic cells.
